(19) United States
(12) Patent Application Publication
(10) Pub. No.: US 2011/0282718 A1
(43) Pub. Date: Nov. 17, 2011

(54) INTERACTIVE LOCATION BASED AUTOMATED GUIDE SERVICE

(76) Inventors: Naquib U. Hatami, Bristow, VA (US); Martin Georgievski, Reston, VA (US)

(21) Appl. No.: 12/780,666

(22) Filed: May 14, 2010

(51) Int. Cl. G01C 21/00; G06Q 30/00

(52) U.S. Cl. 705/14.1; 701/201; 705/14.4

(57) ABSTRACT

A location based remote guidance system suitable for supervising tours of a locale being undertaken by tourists. The system may transmit and annunciate messages relating to points of interest throughout the locale and also to availability of supporting goods and services, all based on proximity to the tourists. The system may utilize stationary beacons disposed throughout the locale to ensure reliability of location based messages. The system may be operated as a commercial service which supervises self-guided tours by subscribers solicited directly by the operator of the system, and also on a compensated basis which supervises self-guided tours undertaken by subscribers solicited by other tourist related commercial entities.

### FIELD OF THE INVENTION

The present invention relates to location based navigation services, and more particularly to a navigation service enabling a user to be self-guided throughout a selected geographic area and to receive stored commentary relative to identified sites throughout the selected geographic area.

### BACKGROUND OF THE INVENTION

Tourists frequently enjoy touring places which are new to them. Because these places are new, it follows that a tourist does not have sufficient knowledge of local roads so as to efficiently navigate through the selected site of a tour. Also, tourists often have difficulty in finding and recognizing places of special interest in the selected touring site.

Professional tour guides have long offered chauffeur services in which the guide provides a transportation vehicle and frequently, commentary on places of special interest as each is passed in the course of a chauffeured tour. However, professionally guided tours may be fairly expensive, and usually have predetermined routes which may ignore some places of interest to individual tourists, and which may include undesired touring places of interest. In Washington, D.C. for example, half day tours may cost as much as one hundred twenty-five dollars, and full day tours as much as two hundred dollars.

The problem is further appreciated by considering the following aspects of the example of Washington, D.C. Points of interest may include the Smithsonian Institution, or eve just the National Museum of Natural History, just the National Air and Space Museum; the Lincoln Memorial; the Roosevelt Memorial; the Tidal Basin; the World War II Memorial; the Vietnam Veterans Memorial; the Korean War Memorial; the Franklin D. Roosevelt Memorial; Rock Creek Park; Capitol Hill; the White House and surrounding historic locations; Dupont Circle; Georgetown; the Waterfront district; the Naval Observatory; National Cathedral, and others. Washington, D.C. is also home to four major sporting event venues with 167,000 total seats and eight major professional teams including the Redskins, Wizards, Mystics, Nationals, United and Capitals. There are more than forty performing arts/theatre venues with 31,000 total seats. The effective area encompassing the above attractions is on the order of twenty-three square miles. It is little wonder that more than fifty private tour companies offer nearly forty regularly scheduled tours.

However, in addition to high charges for touring services, these tours are typically pre-arranged and therefore not susceptible to being personalized. It would be possible for tourists to utilize recently developed navigational aids. However, these aids typically are directed to a single destination, or alternatively, must have plural destinations individually loaded into a database. This latter step is both tedious and also presumes awareness by the user of every potential place of interest. This presumption is frequently erroneous. Navigational aids may also be susceptible to disruption or interference due to adverse atmospheric influences such as weather.

There exists a need for an automated, interactive system which can guide a tourist through a site of a tour and which has an inventory of specific attractions which are predictably of interest to tourists, and which can provide audible commentary on passing attractions.

### SUMMARY OF THE INVENTION

The present invention provides an automated, interactive system for guiding tourists. The system can present information to a tourist in audible form, thereby reproducing the effect of a live tour guide. The system can respond to location, for example by utilizing a GPS enabled device. Informational messages may therefore be correlated to the actual location of the tourist.

Informational messages may be delivered to individualized communications devices such as cellular telephones, or alternatively delivered by a single device to plural listeners, such as by a speaker carried aboard a vehicle.

The database of the system may be updated in real time, such as by connection to the internet. Signals may be distributed by a low powered system such as Bluetooth®.

The system may be operable to issue navigation aids to selected points of interest. The system may be updated so as to route the tourist around congested areas, construction areas, and other obstacles to the usual orderly flow of traffic.

In a further aspect, the system may be administered as a business, wherein the tourists may be subscribers to the system. Furthermore, the system may encompass commercial sponsors, for example, businesses which offer goods and services to tourists, such as restaurants, hotels, camera and supply vendors, parking facilities, restroom facilities, and the like. The system may present virtual coupons for commercial sponsor products to the tourists.

The novel system has the advantages of greatly decreasing costs to tourists over guided tours; allowing personalized or customized tours, since a tourist traveling in his or her own vehicle can ignore a passing point of interest and choose points of interest to observe; allowing a tourist to avoid congestion; and of being advised of local commercial support products and services, and of being provided with discounts for the same. At the same time, the novel system provides a commercial opportunity for a business entity to administer the system.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a diagrammatic side view of apparatus used in the novel remote guidance system according to at least one aspect of the invention.

FIG. 2 is a block diagram of steps of a method of practicing the invention according to at least one aspect of the invention.

### DETAILED DESCRIPTION

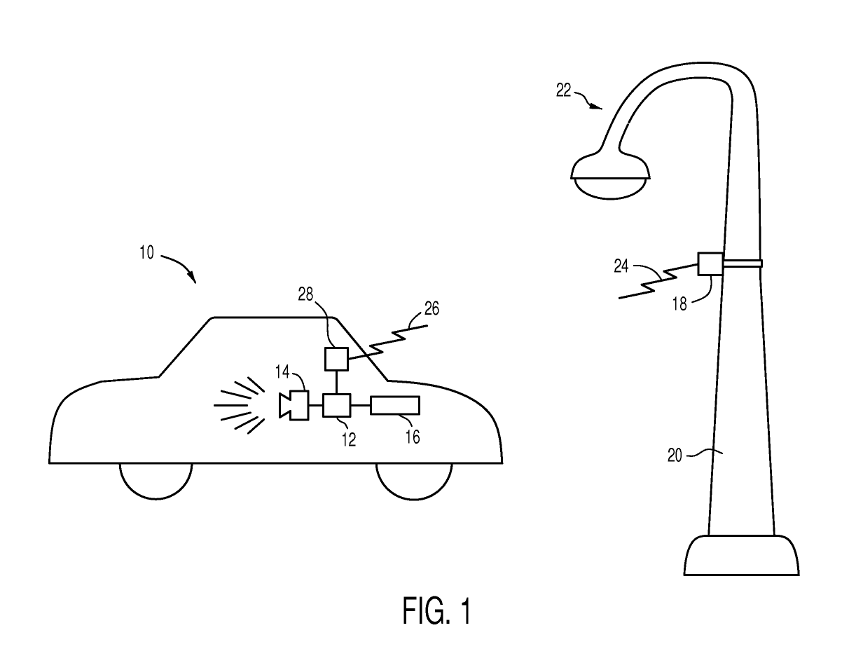

Referring first to FIG. 1, according to at least one aspect of the invention, there is shown apparatus for implementing a remote guidance system suitable for supervising tours of a locale being undertaken by tourists. The remote guidance system is primarily intended for use in motorized vehicles such as an automobile 10, but of course may be implemented in non-motorized vehicles such as horse drawn vehicles (not shown) and by tourists traveling on foot. The automobile 10 is a vehicle which conducts one or more tourists (not shown) throughout the locale featuring a plurality of points of interest. The apparatus includes a data processor 12, a mobile annunciator 14 for annunciating description of points of interest proximate the mobile annunciator 14, disposed in communication with the data processor 12, and a data storage device 16 containing data pertaining to pre-identified points of interest located within the locale. The data storage device 16 may be a separate component from the data processor 12, disposed in communication with the data processor 12, or may be integral with the data processor 12.

The remote guidance system includes a location determining facility disposed in communication with the data processor 12. The remote guidance system may comprise a number of components working in conjunction with one another and therefore may not be a discrete physical component unto itself, such as a commercially available Global Positioning System (GPS) unit (not shown). In one implementation of the remote guidance system, the location determining facility comprises a plurality of beacons such as a beacon 18 shown attached to the vertical pole 20 of a street light 22. To be fully functional in a large geographic area, such as the city of Washington, D.C., a plurality of such beacons may be located throughout the locale. The beacons may be mounted in any suitable way and to many different structures, not being limited to street lights or to pole mounting, which examples are merely illustrative. The beacon 18 may issue location signals 24 which identify location within the locale of that particular beacon 18.

The beacon 18 assures that suitable location identifying signals be made available to the users of the remote guidance system despite conditions which may be present which could defeat operation of other types of location identifying systems such as those based on GPS. For example, weather conditions which could interfere with GPS signal reception may be inadequate to interfere with signals 24 issued by the beacon 18.

The beacon 18 may be of the type which constantly or periodically transmits data signals 24, or alternatively may operate only interactively, for example, transmitting data signals 24 in response to a prompting or querying signal 26 which may be transmitted from a transceiver 28 carried on the automobile 10. The data signals 24 and 26 may operate by a low powered transmission protocol such as Bluetooth® for example.

Each beacon transmits data identifying the unique location of that particular beacon within the locale being served, so that nearby points of interest may be identified to the tourists. For the purposes of the present invention, points of interest may include buildings, specific locations, statues, monuments, natural geologic formations, bodies of water, forests, gardens, and other flora, military, marine, religious, educational, and technical facilities, historic sites, and other attractions which are generally held to be of interest to the touring public.

The data processor 12 is operable to retrieve data corresponding to description of points of interest from the data storage device 16, to identify points of interest which are proximate the location determining facility, and to generate description of points of interest for annunciation by the mobile annunciator 14 responsively to identifying points of interest which are proximate the location determining facility. The annunciator 14 may be of the audible type, comprising a voice synthesizer (not separately shown) for example, which may broadcast pre-recorded verbal messages to occupants of the automobile 10.

It should be mentioned at this point that messages delivered to tourists in the automobile 10 may be visual as well as audible, if desired. For example, the annunciator 14 may be replaced or supplemented by a visual device (not shown) having a display screen. Information presented audibly by the annunciator 14 may be supplemented by information presented visually.

Regardless of whether information delivery is audible or visual or both, the remote guidance system may be interactive in that tourists in the automobile 10 may interactively enter commands, preferences, queries and other communications to the system if desired. The mobile annunciator may annunciate advertising content Advertising content may include virtual coupons. A virtual coupon may comprise notification that as a subscriber to the novel remote guidance system, the recipient is authorized to enjoy discounts from the usual price of advertised goods and services.

Conditions of the discounts may include proof of subscribership. For example, an authorizing code, such as a word, name, alphnumeric symbol, or the like may be transmitted to the subscriber, who may be authorized by merely verbally repeating the authorizing code upon visiting the premises of the advertised goods and services for example.

Goods and services may be of the type which specifically support tourist activities, in addition to content relating to the points of interest. For example, goods may include refreshments, souvenirs, camera supplies, first aid and other comfort items, and others. Support services may include vehicle parking resources, bath facilities, other information not available through the remote guidance system, such as access to reservation systems for hotels and motels, restaurants, and other facilities, access to the internet, banking services, and still others. Support services may include traffic advisories, for example, including warnings of collision, fires, and other emergency situations, and also warnings of traffic congestion which may be normal or abnormal.

It will be apparent that the novel remote guidance system may result in a number of efficiencies. Traffic flow and management may be improved by reliance on the traffic advisories. Identification of desired restaurants and other goods and service suppliers may be performed with much greater efficiency by tourists, who might otherwise be unaware of identities and proximity of restaurants and other goods and service suppliers. Also, restaurants and other suppliers may operate at greater capacity than would otherwise be the case, thereby increasing volume of business even when discounts come into play.

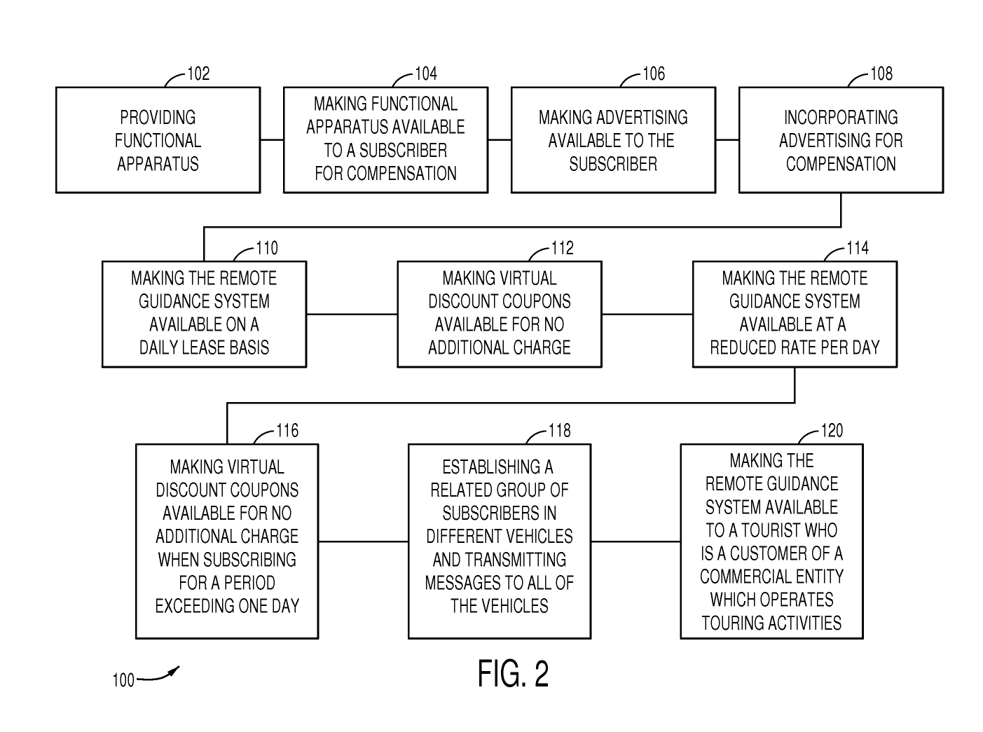

If desired, annunciated information relating to the support services may be accessed by the tourist on demand by interaction with the remote guidance system. For example, the transceiver 28 may comprise a microphone (not separately shown) audible messages Referring now to FIG. 2, according to at least one further aspect, the invention may be a method 100 of operating a commercial service which provides a remote guidance system suitable for supervising tours of a locale being undertaken by tourists. The method 100 may utilize the apparatus described above, and may comprise the following steps.

The method 100 may comprise a step 102 of providing functional apparatus including a data processor such as the data processor 12, a mobile annunciator for annunciating description of points of interest proximate the mobile annunciator, such as the mobile annunicator 14, disposed in communication with the data processor, a data storage device such as the data storage device 16 containing data pertaining to pre-identified points of interest located within the locale, wherein the data storage device 16 is disposed in communication with the data processor 12, and a location determining facility disposed in communication with the data processor 12. The data processor 12 is operable to retrieve data corresponding to description of points of interest from the data storage device, to identify points of interest which are proximate the location determining facility, and to generate description of points of interest for annunciation by the mobile annunciator 14 responsively to identifying points of interest which are proximate the location determining facility.

The method 100 may comprise a step 104 of making the functional apparatus operably available to at least one tourist subscriber to the remote guidance system in exchange for monetary compensation paid to the commercial service by the tourist.

The method 100 may comprise a step 106 of making advertising information relating to commercial support services available to the tourist subscriber, and a related step 108 of incorporating the advertising information relating to commercial support services available to commercial sponsors in exchange for monetary compensation paid to the commercial service by each commercial sponsor.

The method 100 may comprise a step 110 of making the services of the remote guidance system available on a daily lease basis to each tourist subscriber at an established standard daily lease rate, which may in one example be five dollars per day.

The method 100 may comprise a step 112 of making the virtual discount coupons available to tourist subscribers for no additional charge beyond the established standard daily lease rate. This feature may improve the attractiveness of the system.

The method 100 may comprise a step 114 of making the services of the remote guidance system available to each tourist subscriber for a period exceeding one day at a reduced rate per day which is less than the established standard daily lease rate. For example, an agreement to utilize the system for three successive days may incur a charge of ten dollars, which represents a five dollar savings over the single-day lease rate cited above. The virtual discount coupons may be deleted from single day usages, but made available to multiple day usages as a bonus feature above and beyond any discounts to daily system use charges. For example, a three day usage may incur charges of ten dollars, but may also include virtual discounts.

The method 100 may comprise a step 116 of making the virtual discount coupons available to tourist subscribers for no charge beyond the reduced rate per day, but only when tourist subscribers subscribe for a period exceeding one day at a reduced rate per day.

The method 100 may comprise a step 118 of pre-establishing plural tourist subscribers traveling in different vehicles as a related group of tourist subscribers, and transmitting supervisory messages pertaining to that one group of tourist subscribers to all of the different vehicles of the related group of tourist subscribers. The transceivers of all of the vehicles, such as the transceiver 28, may be adapted to intercommunicate to implement the step 118. In an example, a single day group rate of fifteen dollars may apply to groups of related vehicles, with up to six vehicles participating. It is contemplated that one person will be established as a supervisor, who has the ability to track location of each of the related vehicles. It would be possible to establish an audible or visible alert when any one member of the group of related vehicles reaches a particular geographic point, or deviates from other in the group by a predetermined distance.

The method 100 may comprise the further step 120 of making the functional apparatus operably available to at least one tourist who has been obtained as a paying customer by a commercial entity which directly operates and supervises touring activities in exchange for monetary compensation paid to the commercial service by the commercial entity which directly operates and supervises touring activities. In this step, the commercial entity which operates and supervises touring activities is different from that which operates the remote guidance system which includes the functional apparatus shown in FIG. 1. Alternatively stated, the commercial entity which operates the remote guidance system leases or otherwise transfers rights to utilize the remote guidance system to the second commercial entity. Compensation is paid by the second commercial entity to the commercial entity which operates the remote guidance system. The customers of the second commercial entity are not the actual customers of the commercial entity which operates the remote guidance system. These customers may be unaware of the existence or role of the commercial entity which operates or provides the remote guidance system.

Of course, some of the operating aspects of the remote guidance system may be shared or divided between the two commercial entities. For example, it would be possible for the second commercial entity to limit its use of the remote guidance system to using the beacons such as the beacon 18 as location cues. In a further example, it would be possible for the second commercial entity to use all of the apparatus shown in FIG. 1, but to provide its own commentary or descriptive content as points of interest elicit annunciated description or content as they are encountered by the tourists.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

We claim:

1. A remote guidance system suitable for supervising tours of a locale being undertaken by tourists, comprising:
a data processor;
a mobile annunciator for annunciating description of points of interest proximate the mobile annunciator, disposed in communication with the data processor;
a data storage device containing data pertaining to pre-identified points of interest located within the locale, wherein the data storage device is disposed in communication with the data processor; and
a location determining facility disposed in communication with the data processor, wherein
the data processor is operable to retrieve data corresponding to description of points of interest from the data storage device, to identify points of interest which are proximate the location determining facility, and to generate description of points of interest for annunciation by the mobile annunciator responsively to identifying points of interest which are proximate the location determining facility.

2. The remote guidance system of claim 1, wherein the annunicator is an audible annunciator.

3. The remote guidance system of claim 1, wherein the location determining facility comprises a plurality of beacons disposed throughout the locale being toured by the tourists, and wherein each one of the plurality of beacons signals location within the locale of that beacon.

4. The remote guidance system of claim 3, wherein each one of the beacons communicates by a low powered transmission protocol.

5. The remote guidance system of claim 1, wherein the mobile annunciator annunciates advertising content.

6. The remote guidance system of claim 5, wherein the advertising content includes virtual discount coupons.

7. The remote guidance system of claim 1, wherein the mobile annunciator annunciates support services in addition to content relating to the points of interest.

8. The remote guidance system of claim 7, wherein annunciated information relating to the support services may be accessed by the tourist on demand by interaction with the remote guidance system.

9. The remote guidance system of claim 7, wherein the support services include vehicle parking resources.

10. The remote guidance system of claim 7, wherein the support services include bath facilities.

11. The remote guidance system of claim 7, wherein the support services include traffic advisories.

12. A method of operating a commercial service which provides a remote guidance system suitable for supervising tours of a locale being undertaken by tourists, comprising the steps of:
providing functional apparatus including a data processor, a mobile annunciator for annunciating description of points of interest proximate the mobile annunciator, disposed in communication with the data processor, a data storage device containing data pertaining to pre-identified points of interest located within the locale, wherein the data storage device is disposed in communication with the data processor, and a location determining facility disposed in communication with the data processor, wherein the data processor is operable to retrieve data corresponding to description of points of interest from the data storage device, to identify points of interest which are proximate the location determining facility, and to generate description of points of interest for annunciation by the mobile annunciator responsively to identifying points of interest which are proximate the location determining facility; and
making the functional apparatus operably available to at least one tourist subscriber to the remote guidance system in exchange for monetary compensation paid to the commercial service by the tourist.

13. The method of claim 12, comprising the further steps of
making advertising information relating to commercial support services available to the tourist subscriber; and
incorporating the advertising information relating to commercial support services available to commercial sponsors in exchange for monetary compensation paid to the commercial service by each commercial sponsor.

14. The method of claim 12, wherein the remote guidance system is operable to deliver virtual discount coupons relating to the commercial support services from the mobile annunciator to at least one tourist subscriber.

15. The method of claim 12, comprising a further step of making the services of the remote guidance system available on a daily lease basis to each tourist subscriber at an established standard daily lease rate.

16. The method of claim 15, comprising a step of making the virtual discount coupons available to tourist subscribers for no charge beyond the established standard daily lease rate.

17. The method of claim 15, comprising a step of making the services of the remote guidance system available to each tourist subscriber for a period exceeding one day at a reduced rate per day which is less than the established standard daily lease rate.

18. The method of claim 17, comprising a step of making the virtual discount coupons available to tourist subscribers for no charge beyond the reduced rate per day.

19. The method of claim 12, comprising a step of pre-establishing plural tourist subscribers traveling in different vehicles as a related group of tourist subscribers, and transmitting supervisory messages pertaining to that one group of tourist subscribers to all of the different vehicles of the related group of tourist subscribers.

20. The method of claim 12, comprising the further step of making the functional apparatus operably available to at least one tourist who has been obtained as a paying customer by a commercial entity which directly operates and supervises touring activities in exchange for monetary compensation paid to the commercial service by the commercial entity which directly operates and supervises touring activities.
